(19) United States
(12) Patent Application Publication
(10) Pub. No.: US 2013/0077895 A1
(43) Pub. Date: Mar. 28, 2013

(54) HEATABLE PACKAGE BAG

(71) Applicants: Bo-Xin JIAN, New Taipei City (TW); Yaw-Shin Liao, New Taipei City (TW); Kao-Hsiung Liao, New Taipei City (TW)

(72) Inventors: Bo-Xin JIAN, New Taipei City (TW); Yaw-Shin Liao, New Taipei City (TW); Kao-Hsiung Liao, New Taipei City (TW)

(21) Appl. No.: 13/307,535

(22) Filed: Nov. 30, 2011

(30) Foreign Application Priority Data
Sep. 28, 2011 (TW) 100135055

(51) Int. Cl. B65D 30/24; B32B 37/02; B32B 38/04

(52) U.S. Cl. 383/45; 156/253; 156/252

(57) ABSTRACT

A heatable package bag includes two sheets of outer film, a plurality of projections, a plurality of guiding channels and a plurality of pre-breakage portions, where the two sheets of outer film includes a plurality of inner surfaces, a storage space is formed among the plurality of inner surfaces, adapted to receive an article; the plurality of projections is positioned on the plurality of inner surfaces, adapted to support the surface of the article; the guiding channels are positioned among the projections, the air in the storage space flows along the guiding channels; and the pre-breakage portions are positioned on the guiding channels. The air in the storage space is expanded to compress the two sheets of outer film during heating, and the plurality of pre-breakage portions is broken, allowing the air to flow out of the storage space via the plurality of pre-breakage portions.

### CROSS-REFERENCES TO RELATED APPLICATIONS

This non-provisional application claims priority under 35 U.S.C. §119 (a) on Patent Application No(s). 100135055 filed in Taiwan, R.O. C. on Sep. 28 2011, the entire contents of which are hereby incorporated by reference.

### TECHNICAL FIELD

The present invention relates to a package bag structure, and more particularly to a heatable package bag.

### BACKGROUND

A diet of convenience food is popular among modern busy-working people, such that the food market is flooded with prepared food packages containing vegetable, seafood or meat. Prepared food packages are unfrozen and heated in a microwave oven before eating, and can be eaten in a very short time.

However, prepared food packages or other hermetically sealed food packages available in markets are made mostly of plastic films with low air permeability. As a result, the temperature and pressure of the air in the sealed package will be increased quickly, leading to bursting, which may damage the package during the heating of a microwave oven if the air permeation of the plastic film is insufficient and its critical tensile strength is reached.

To solve this problem, a user usually cuts an opening or poke a hole at one end of a package bag, allowing high-pressure and high-temperature air to escape through the opening or hole during the heating of the micro oven, thereby preventing internal pressure in the package from increasing suddenly to bursting point.

### SUMMARY

In view of this problem, the present invention proposes a heatable package bag, including: two sheets of outer film, including a plurality of inner surfaces, a storage space used for receiving an article being formed among the plurality of inner surfaces; a plurality of projections used for supporting a surface of the article, positioned on the plurality of inner surfaces and projected out of the plurality of inner surfaces; a plurality of guiding channels, positioned among the plurality of projections of the plurality of inner surface, air in the storage space flowing along the plurality of guiding channels; and a plurality of pre-breakage portions, positioned on the plurality of guiding channels of the plurality of inner surfaces, air in the storage space being expanded during heating to press the two sheets of outer film, breaking the plurality of pre-breakage portions, thereby allowing the air to flow out of the storage space via the plurality of pre-breakage portions.

The present invention also proposes a method for making a heatable package bag, including: providing two sheets of outer film, the two sheets of outer film including a plurality of inner surfaces; configuring a plurality of projections on at least one of the plurality of inner surfaces, and forming a plurality of guiding channels among the plurality of projections; adhering circumferences of the two sheets of outer film to each other by means of hot sealing to form a storage space among the plurality of inner surfaces, and spot-hitting at least one of the plurality of inner surfaces to for a plurality of pre-breakage portions on the plurality of inner channels, where air in the storage space is expanded during heating to press the two sheets of outer film after the storage space is sealed, breaking the plurality of pre-breakage portions to allow the air to flow out of the storage space via the plurality of pre-breakage portions.

The present invention also proposes a method for making a heatable package bag, including: providing two sheets of outer film, the two sheets of outer film including a plurality of inner surfaces; spot-hitting at least one of the plurality of inner surfaces to form a plurality of pre-breakage portions; adhering the two sheets of outer film to each other by means of hot sealing to form a plurality of projections on at least one of the plurality of inner surfaces, and forming a plurality of guiding channels among the plurality of projections, where the plurality of pre-breakage portions on the plurality of projections is eliminated by hot press; and adhering circumferences of the two sheets of inner film to each other by means of hot sealing to form a storage space among the plurality of inner surfaces, where air in the storage space is expanded during heating to press the two sheets of outer film after the storage space is sealed, breaking the plurality of pre-breakage portions to allow the air to flow out of the storage space via the plurality of pre-breakage portions.

According to the present invention, the plurality of projections is disposed on the inner surfaces of the package bag, adapted to prevent an article from attaching closely to the outer film to affect the heating efficiency. In addition, the plurality of guiding channels is formed among the plurality of projections according to the present invention, guiding air flow, allowing the article to be heated uniformly, thereby increasing the heating effect. Furthermore, since the plurality of pre-breakage portions is disposed on the plurality of guiding channels according to the present invention, the plurality of pre-breakage portions is broken to allow air to flow out of the storage space via the plurality of pre-breakage portions when the air is heated to expand to press the two sheets of outer film, thereby avoiding bursting and damage to the package effectively, and solving the inconvenience in the prior art, caused by the necessity of cutting an opening or poking a hole in advance.

### BRIEF DESCRIPTION OF THE DRAWINGS

The present invention can be more fully understood by reference to the following description and accompanying drawings, wherein:

FIG. 1 is a schematically perspective view of a first preferred embodiment according to the present invention;

FIG. 2 is a schematically partly enlarged view of a portion A shown in FIG. 1;

FIG. 3 is a schematically cross sectional view taken along line B-B′ of FIG. 1;

FIG. 4 is a schematically perspective view of the first embodiment according to the present invention while being in use;

FIG. 5 is a laterally cross sectional view of the first embodiment according to the present invention while being in use;

FIG. 6 is a laterally cross sectional view of the first embodiment according to the present invention while air is heated to expand;

FIG. 7 is a schematically partly enlarged view of a portion C shown in FIG. 6; and

FIG. 8 is a schematically perspective view of a second preferred embodiment according to the present invention.

### DETAILED DESCRIPTION

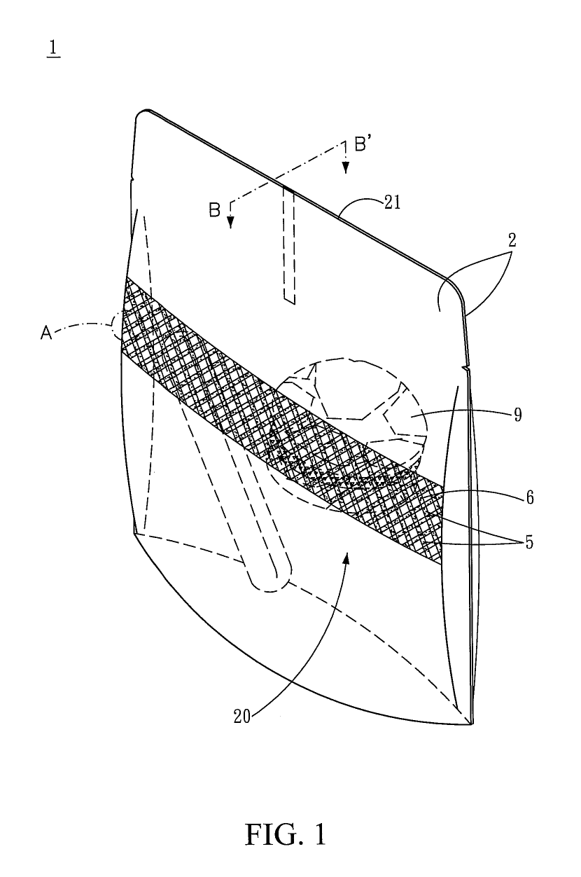

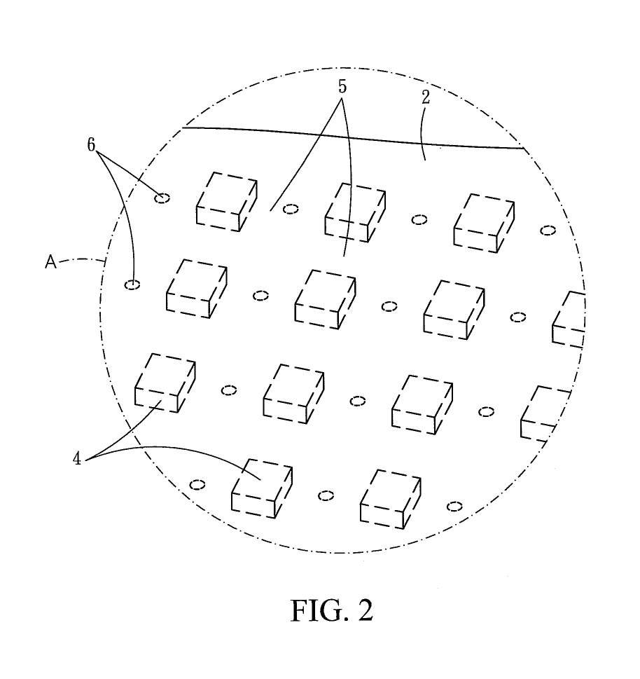

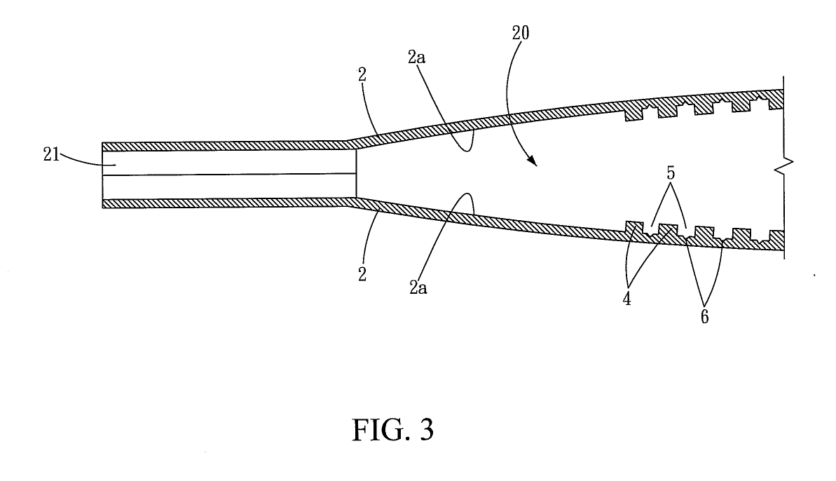

FIGS. 1, 2 and 3 schematically a heatable package bag 1 of a first preferred embodiment according to the present invention.

The heatable package bag 1 includes two sheets of outer film 2, a plurality of projections 4, a plurality of guiding channels 5 and a plurality of pre-breakage portions 6.

The two sheets of outer film 2 are stacked together, and the circumferences of the two sheets of outer film 2 are adhered to each other by means of hot sealing to form a bag structure. The two sheets of film 2 respectively have an inner surface 2a opposite to each other, a storage space 20 is formed between the plurality of face-to-face inner surfaces 2a, and one end of the storage space 20 has an opening 21. The two sheets of outer film 2 can be made from a hot-meltable hot-sealing material such as polyester, ethylene propylene copolymer, ethylene styrene copolymer (ES), cycio olefin, Polyethylene terephthalate (PET), Polyvinyl alcohol (PVA), ethylene vinyle acetate (EVA), polyethylene naphthalate (PEN), Polypropene (PP), nylon, ionomer, biodegradable materials, Polyether ether ketone (PEEK), polycarbonate (PC), Polyimide (PI), Peroxyacetyl nitrate (PAN), Acrylonitrile styrene copolymer (SAN), polyurethane (PU), glassine paper or polymer coated paper; however, these are exemplary and explanatory only, the present invention is not limited to them.

The plurality of projections 4 are disposed on the plurality of inner surfaces 2a, and projected our of the plurality of inner surfaces 2a, where the plurality of projections 4 are formed integrally on the plurality of inner surfaces 2a by adhering the two sheets of inner film 2 by means of hot sealing; but, the way of integrating the plurality of projections 4 with the plurality of inner surfaces 2a is explanatory only, the plurality of projections 4 may also be independent elements that are positioned on the plurality of inner surfaces 2a by way of adhering or other fixations. Furthermore, the plurality of projections 4 may be distributed completely on the plurality of inner surfaces 2a, or only distributed partly on the plurality of inner surfaces 2a depending on a practical structure requirement.

The plurality of guiding channels 5 are positioned among the plurality of projections 4 of the plurality of inner surfaces 2a, where the plurality of guiding channels 5 are respectively arranged on the plurality of inner surfaces 2a in a first direction and a second direction which are intersected with each other, where the included angle of the first and second directions may be a right angle or obtuse angle depending on a practical structure requirement. In addition, the plurality of guiding channels 5 may be arranged simultaneously on the inner surfaces 2a of one of the two sheets of outer film 2 in the first and second directions, and the plurality of guiding channels 5 on the inner surface 2a of another outer film 2 are arranged similarly. Otherwise, the plurality of guiding channels 5 may be arranged on one of the inner surface 2a of one of the two sheets of outer film 2 in the first direction, and on the inner surface 2a of another outer film 2 in the second direction. Furthermore, at least one part of the plurality of guiding channels 5 may be arranged parallel to one another. However, the arrangement of the plurality of guiding channels 5 mentioned above is exemplary only; the present invention is not limited to them.

The plurality of pre-breakable portions 6 are positioned on the plurality of guiding channels 5 of the plurality of inner surfaces 2a, where the places of the two sheet of outer film 2 on which the plurality of pre-breakage portions 6 are disposed are thinner than other places. As a result, micro-holes will be yielded at the pre-breakage portion 6 when the two sheets of outer film 2 are pressed and the pressure exceeds a critical tensile strength that they can endure.

In the present embodiment, electrical shock is exerted on the plurality of guiding channels 5 of the inner surface 2a by a shock generator (e.g. ultrasonic shock generator), to form a concave and convex surface on the inner surface 2a; the places exerted by the ultrasonic electrical shock are thinner concave portions, forming the pre-breakage portions 6, and the projections 4 are not exerted by the electrical shock and do not become thinner in comparison with the pre-breakage portions 6 such that they are higher than the pre-breakage portions 6. In other words, the places of the outer film 2 on which the projections 4 are positioned are thicker than the places of the outer film 2 on which the pre-breakage portions 6 are positioned. Furthermore, the plurality of thinner pre-breakage portions 6 may be formed on the inner surface 2a by exerting electrical shock on the inner surface 2a through a shock generator (e.g. Ultrasonic shock generator), the inner surface 2a is then hot-pressed by means of hot sealing to form the plurality of projections 4, and the plurality of guiding channels 5 are formed among the plurality of projections 4, where the pre-breakage portion 6 positioned on the projection 4 is hot-pressed, filled and leveled up and wiped out finally, so only the plurality of pre-breakage portions 6 positioned on the plurality of guiding channels 5 are left over.

In addition to the description mentioned previously, a method for forming the plurality of pre-breakage portions may also use such as a concentric circle die extrusion injection process to obtain cylindrical pull bag style of blow bag, a tenter for stretching, or extrusion injection, and may perform a film stretching process at a temperature lower than or close to a material softening point. However, the methods for forming the plurality of pre-breakage portions 6 mentioned previously are exemplary and explanatory only, the present invention is not limited to these.

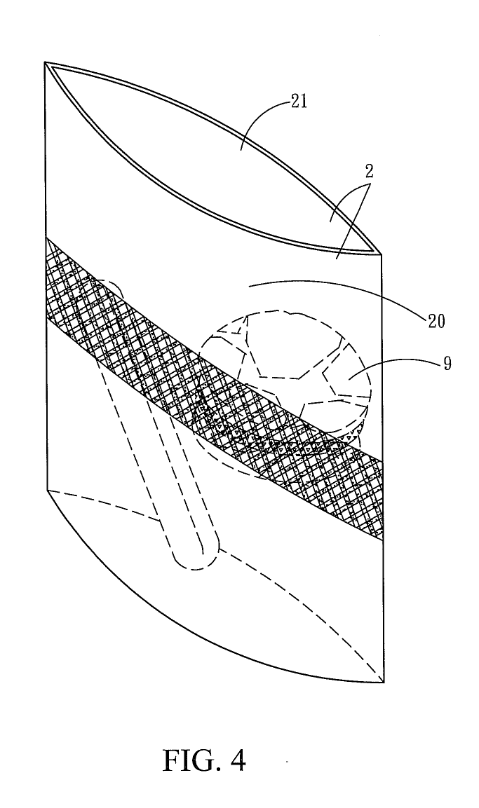

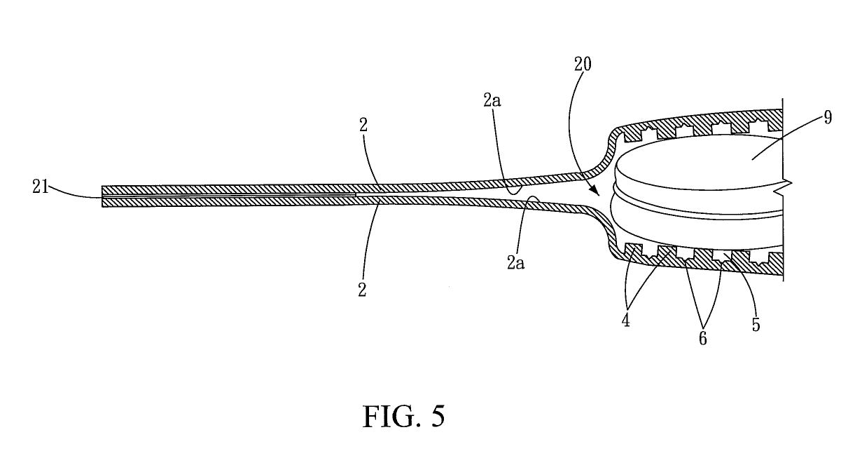

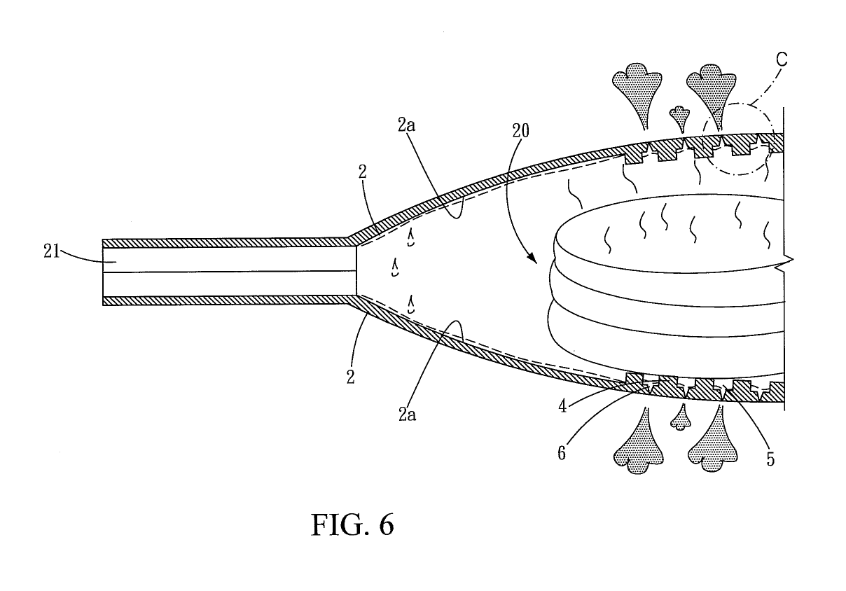

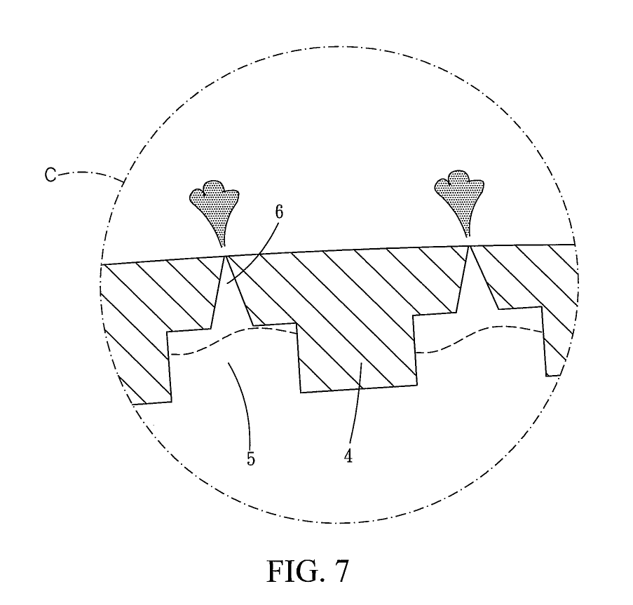

Please refer to FIGS. 4, 5, 6 and 7, in which an article 9 is placed in the storage space 20 via the opening 21, the plurality of projections 4 are used to support the surface of the article 9, allowing the article 9 not to attach closely to the inner surface 2a of the outer film 2. Subsequently, a suction device or vacuum pump is used to draw the air out of the storage space 20; the air in the storage space 20 may flow to the outside along the plurality of guiding channels 5. Finally, the two sheets of outer film 2 at the opening 21 are adhered together by means of hot sealing, thereby sealing the storage space 20.

A user may use a microwave oven, high temperature steam, water boiling or infrared heating to heat the article 9. The article 9 is at a lower temperature and the vapor pressure in the storage space 20 is smaller during the initial heating, the overwhelming part of microwave energy is converted to heat energy through the vibration and friction of the molecules of the sealed article 9, and since the plurality of projections 4 support the surface of the article 9 to prevent it from attaching closely to the inner surface 2a, the article 9 can be heated uniformly effectively. Furthermore, the plurality of guiding channels 5 can guide the air to flow along them during the heating. As a result, the heating effect can be increased. The temperature and the vapor pressure in the storage space 20 are increased when the heating time is longer, the air in the storage space 20 expands outward to compress the two sheets of outer film 2, the plurality of pre-breakage portions 6 are also deformed and expanded as well, becoming thinner gradually and even broken. At this time, the broken pre-breakage portion 6 provides ventilation, and acts as a safety relief valve when the internal air pressure in the storage space 20 is too great, thereby avoiding instant bursting such as happens to a conventional airtight sealed bag due to extreme hot vapor pressure during heating.

Furthermore, since the plurality of pre-breakage portions 6 are configured on the plurality of guiding channels 5 according to the present invention, the guiding channel 5 guiding air flow is not hindered and the effect of breaking the pre-breakage portion 6 is not influenced even if the two sheets of outer film 2 cover the article 9 tightly, because the article 9 is supported by the plurality of projections 4 without contacting with the plurality of guiding channels 5.

A method for making a heatable package bag includes:

step 101: providing two sheets of outer film 2 including a plurality of inner surfaces 2a;

step 102: spot-hitting at least one inner surface 2a to form a plurality of pre-breakage portions 6;

step 103: adhering the two sheets of outer film 2 together by means of hot sealing to form a plurality of projections 4 on at least one inner surface 2a, and form a plurality of guiding channels 5;

The two sheets of outer film 2 are adhered to each other by means of hot sealing to form the plurality of projections 4 on at least one inner surface 2a, and the plurality of guiding channels 5 among the plurality of projections 4, where the plurality of pre-breakage portions 6 positioned on the plurality of projections 4 are hot-pressed to wipe out.

step 104: adhering circumferences of the two sheets of outer film 2 together by means of hot sealing to form a storage space 20 among the plurality of inner surfaces 2a.

The storage space 20 is formed among the plurality of face-to-face inner surfaces 2a, where one end of the storage space 20 has an opening 21 through which a user can place the article 9 into the storage space 20. Subsequently, the storage space 20 is sealed to close the bag structure. The air in the storage space 20 is expanded during heating to compress the two sheets of outer film 2, breaking the plurality of pre-breakage portions 6 to allow the air to flow out of the storage space 20 via the plurality of pre-breakage portions 6. As regards the method for making a heatable package bag, other descriptions are the same as the contents mentioned previously; these are omitted here.

Another method for making a heatable package bag is different from the method mentioned previously as the followings: first, adhering two sheets of outer film 2 together by means of hot sealing to form a plurality of projections 4 on at least one inner surface 2a and a plurality of guiding channels 5, and spot-hitting at least one inner surface 2a to form a plurality of pre-breakage portions 6 on the plurality of guiding channels 5, other descriptions are the same as the contents mentioned previously; these are omitted here.

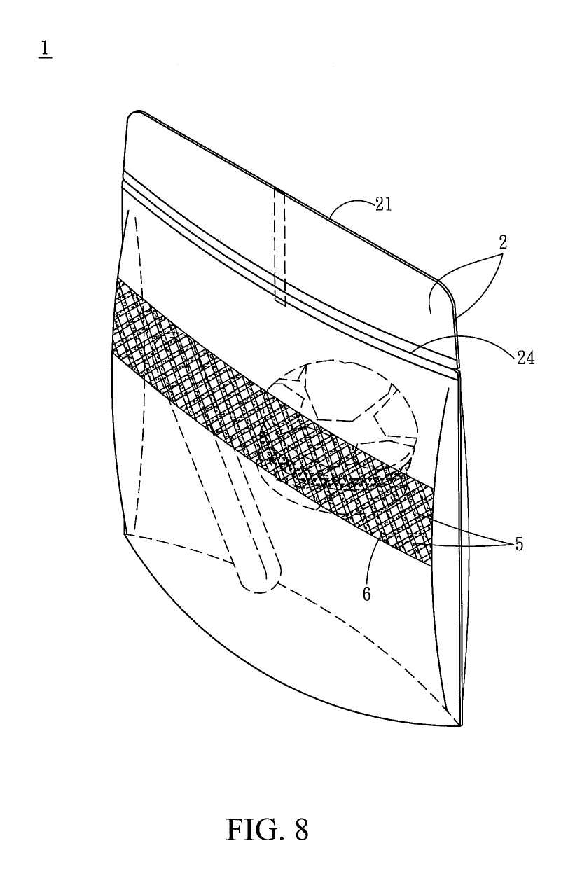

Please refer to FIG. 8, in which a heatable package bag of a second preferred embodiment is disclosed. The biggest difference between the present embodiment and the first embodiment is a sealing structure at the opening 21 of the storage space 20. In the present embodiment, a open-close element 24 such as clip chain, zipper or other clip chain set with a pair of openable and closable male and female elements, used for closing or opening the storage space 20, convenient for a user to insert or remove the article 9.

While the present invention has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A heatable package bag, comprising:
two sheets of outer film, comprising a plurality of inner surfaces, the two sheets of outer film being adhered together by means of hot sealing to form a storage space among the plurality of inner surfaces, adapted to receive an article;
a plurality of projections, positioned on at least one of the plurality of inner surfaces, adapted to support a surface of the article;
a plurality of guiding channels, positioned among the plurality of projections, air in the storage space flowing along the plurality of guiding channels; and
a plurality of pre-breakage portions, positioned on the plurality of guiding channels, the air in the storage space being expanded to compress the two sheets of outer film during heating, and the plurality of pre-breakage portions being broken, allowing the air to flow out of the storage space via the plurality of pre-breakage portions after the storage space is sealed.

2. The heatable package bag according to claim 1, wherein one end of the two sheets of outer film is disposed with a open-close element, adapted to close or open the storage space.

3. The heatable package bag according to claim 1, wherein the plurality of projections is formed integrally on at least one of the plurality of inner surfaces by adhering the two sheets of outer film together by means of hot sealing.

4. The heatable package bag according to claim 1, wherein the plurality of guiding channels is respectively arranged on at least one of the plurality of inner surfaces in a first direction and a second direction.

5. The heatable package bag according to claim 1, wherein the two sheets of outer film are adhered to each other by means of hot sealing to seal the storage space.

6. A method for making a heatable package bag, comprising:
providing two sheets of outer film, the two sheets of outer film comprising a plurality of inner surfaces;
configuring a plurality of projections on at least one of the plurality of inner surfaces, and forming a plurality of guiding channels among the plurality of projections;
adhering circumferences of the two sheets of outer film by means of hot sealing to form a storage space among the plurality of inner surfaces; and
spot-hitting at least one of the plurality of inner surfaces to form a plurality of pre-breakage portions on the plurality of guiding channels, wherein air in the storage space is heated to expanded to compress the two sheets of outer film, and the plurality of pre-breakage portions is broken to allow the air to flow out of the storage space via the plurality of pre-breakage portions after the storage space is sealed.

7. The method according to claim 6, further comprising providing an open-close element, adapted to close or open the storage space after the step of providing two sheets of outer film.

8. The method according to claim 6, wherein the plurality of projections is formed integrally on at least one of the plurality of inner surfaces by adhering the two sheets of outer film together by means of hot sealing in the step of configuring a plurality of projections on at least one of the plurality of inner surfaces.

9. A method for making a heatable package bag, comprising:
providing two sheets of outer film, the two sheets of outer film comprising a plurality of inner surfaces;
spot-hitting at least one of the plurality of inner surfaces to form a plurality of pre-breakage portions;
adhering the two sheets of outer film by means of hot sealing to form a plurality of projections on at least one of the plurality of inner surfaces, and form a plurality of guiding channels among the plurality of projections, wherein the plurality of pre-breakage portion on the plurality of projections is hot-pressed to eliminate; and
adhering circumferences of the two sheets of outer film together by means of hot sealing to form a storage space among the plurality of inner surfaces, wherein air in the storage space is heated to expanded to compress the two sheets of outer film, and the plurality of pre-breakage portions is broken to allow the air to flow out of the storage space via the plurality of pre-breakage portions after the storage space is sealed.

10. The method according to claim 9, further comprising providing an open-close element, adapted to close or open the storage space after the step of providing two sheets of outer film.
